(19) United States
(12) Patent Application Publication
(10) Pub. No.: US 2010/0047490 A1
(43) Pub. Date: Feb. 25, 2010

(54) EYE-LIKE ORNAMENT

(76) Inventor: Min-Hsuan Lin, Taipei (TW)

Correspondence Address: PATENTTM.US, P. O. BOX 82788, PORTLAND, OR, 97282-0788, US

(21) Appl. No.: 12/540,513

(22) Filed: Aug. 13, 2009

(30) Foreign Application Priority Data
Aug. 21, 2008 (TW) 097214998

(51) Int. Cl. B32B 1/00

(52) U.S. Cl. 428/34.1

(57) ABSTRACT

An eye-like ornament, has a body, a base and a pivoting cover. The base is connected with the body. The body is hollow and has an opening centrally formed on a top part of the body. The pivoting cover is pivotally mounted inside the body and has a through hole formed centrally. A plurality of projections curled to face outwards are separately formed on an outer surface beside the through hole. A plumb portion is formed on one end by extending toward an inner portion of the body. Therefore, the projections are inclined to face to another end opposite to the decorative ribs on the body and the through hole is within the opening. The plumb portion maintains the projections at one end of the body exhibiting an appearance resembling an eye-opening look, and the pivotal rotation of the pivoting cover results in another appearance resembling a blinking look.

### BACKGROUND OF THE INVENTION

1. Field of the Invention

The present invention relates to an ornament, and more particularly to an eye-like ornament simulating an eye-opening or eye-closing effect.

2. Description of Related Art

Most ornaments are formed by securely mounting a gem, including, non-precious gems, like glass, semi-precious gems such as cat's eye and genuine gems, on a collet to demonstrate the gem. Some ornaments are designed to demonstrate the gem decoration by either hiding it inside the ornament or simply exposing it.

Ornaments produced with most recent methods include an ornament simulating eye movement having a base, an eyeball-shaped ornament mounted on the base, a decorative piece annularly mounted around the eyeball-shaped ornament and fixedly mounted on the base, and two shutters oppositely and pivotally mounted on two opposite ends of the decorative piece, so as to simulate eye opening and closing. However, the shutters require an external force to be moved relative to the stationary base, and the shutters are normally open or partially closed. Therefore, such ornament is not aesthetically alluring as the gem is not shown.

### SUMMARY OF THE INVENTION

The main objective of the present invention is to provide an eye-like ornament that utilizes momentum generated while wearing to simulate blinking.

To achieve the foregoing, the eye-like ornament of the present invention has a hollow body, a base and a pivoting cover. The hollow body has a top part, a bottom part and an opening centrally formed on the top part. The base is connected with the bottom part of the body. The pivoting cover is pivotally mounted inside the body and has a through hole centrally formed through the pivoting cover, a plurality of projections curled to face outwards, formed on an outer surface of the pivoting cover beside the through hole and separated by a space, and a plumb portion formed on one end abutting the projections and extending toward an inner portion of the body.

Therefore, while using the eye-like ornament of the present invention, the pivoting cover pivotally turns in relation to the opening of the body to locate the through hole within the opening so that the projections stay away from the decorative ribs and similarly exhibit an eye-opening look, or the pivoting cover pivotally turns to an inner portion of the body so that the projections get close to the decorative ribs and similarly exhibit an eye-closing look. As the plumb portion formed by extending one side of the pivoting cover into the body tends to keep the projections away from the decorative ribs, this similarly exhibits a blinking effect when wearer is exercising to pivotally rotate the pivoting cover. As such, in contrast to conventional methods, the present invention simulates blinking without requiring external force and provides an anesthetically alluring ornament.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an eye-like ornament of the present invention;

FIG. 2 is a perspective exploded view of the eye-like ornament of the present invention;

FIG. 3 is a partially cross-sectional view of a side portion of the eye-like ornament of the present invention in a first state;

FIG. 4 is the partially cross-sectional view of the side portion of the eye-like ornament of the present invention in a second state; and

FIG. 5 is another partially cross-sectional view of the side portion of the eye-like ornament of the present invention in the first state.

### DETAILED DESCRIPTION OF THE PREFERRED EMBODIMENT

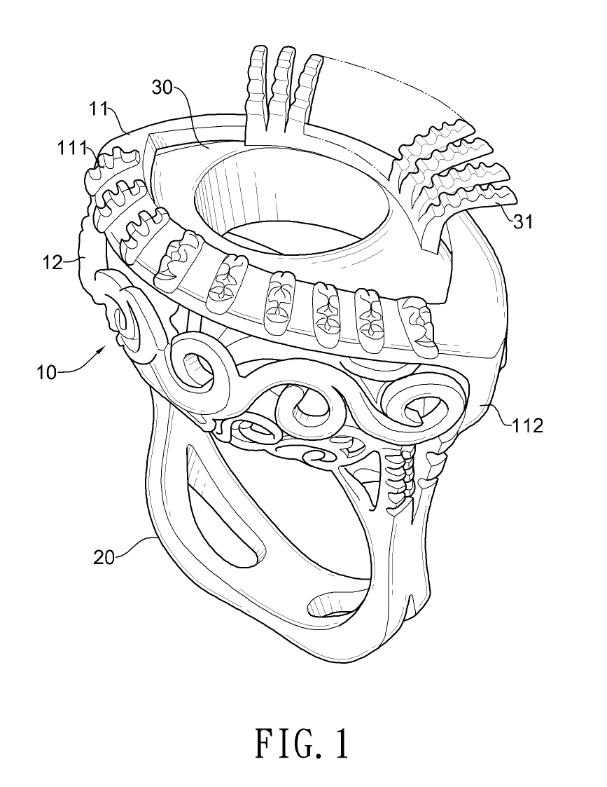

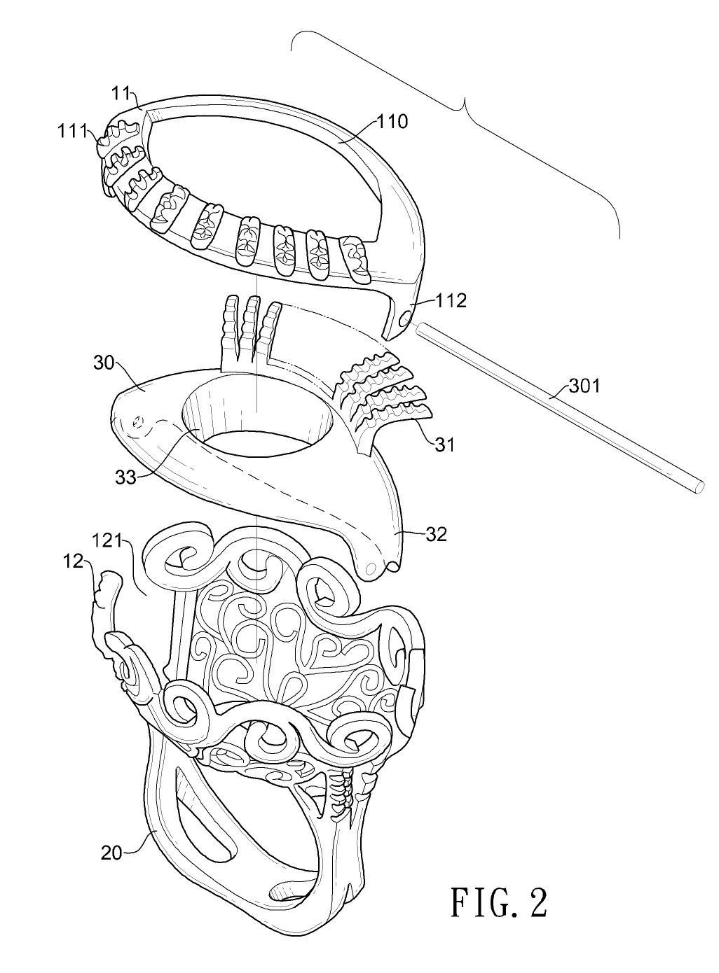

With reference to FIG. 1 and FIG. 2, the eye-like ornament of the present invention has a body (10), a base (20) and a pivoting cover (30).

The body (10) has an ovular and hollow form and has a top part (11) and a bottom part (12). The bottom part has a hollow-out design. An opening (110) is centrally formed on the top part (11) of the body (10). A plurality of decorative ribs (111) are radially mounted on one end of the top part (11) of the body (10) abutting the opening (110) and hemmed with a plurality of jewels such as diamonds. A tab (112) is formed on each of both sides of the top part (11) of the body (10) by extending downwards therefrom. The bottom part (12) of the body (10) is surrounded by a plurality of arc-like decorative stripes hemmed by gems. Two sunken portions are formed on both sides of the bottom part (12) of the body (10) for accommodating the tabs (112) therein. The top part (11) covers the bottom part (12).

The base (20) is connected with the body (10), is preferably formed as a ring to be connected with the bottom part (12) of the body (10) for wearing on a finger, and has a plurality of decorative holes formed therethrough.

The pivoting cover (30) is mounted inside the body (10) and between the top part (11) and the bottom part (12), is pivotally and coaxially mounted on both inner sides of the two tabs (112) by virtue of a pintle (301) to open or close the opening (110), is bent to form a curved surface that faces the top part (11) of the body (10) relative to the bottom part (12) of the body (10) and corresponding to the inner surface of the top part (11) of the body (10), and has a through hole (33) formed centrally and hemmed with gems such as cat's eye and so forth. A plurality of projections (31) separately formed on one end of the pivoting cover (30) opposite to the decorative ribs (111) of the body (10) are curved and protrude outwards. The projections (31) radiate from a center of the through hole (33) and pass through the opening (110) of the top part (11) of the body (10). One end of the pivoting cover (30) abuts the projections (31) and extends toward an inner portion of the body (10) to form a plumb portion (32). The plumb portion (32) keeps those projections (31) away from the decorative ribs (111) of the body (10) and locates the through hole (33) within the opening (110) of the body (10) to similarly exhibit an eye-opening look.

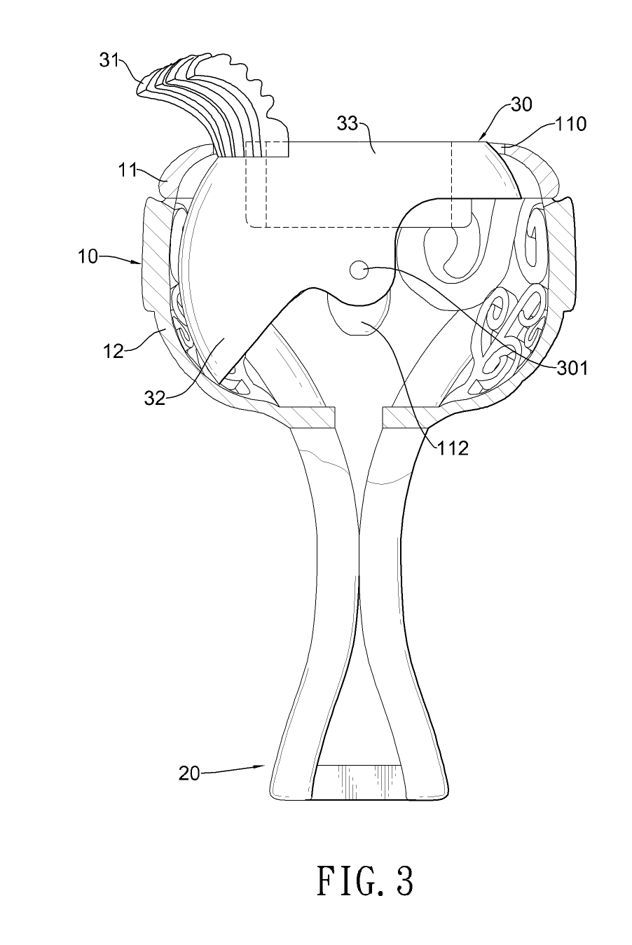

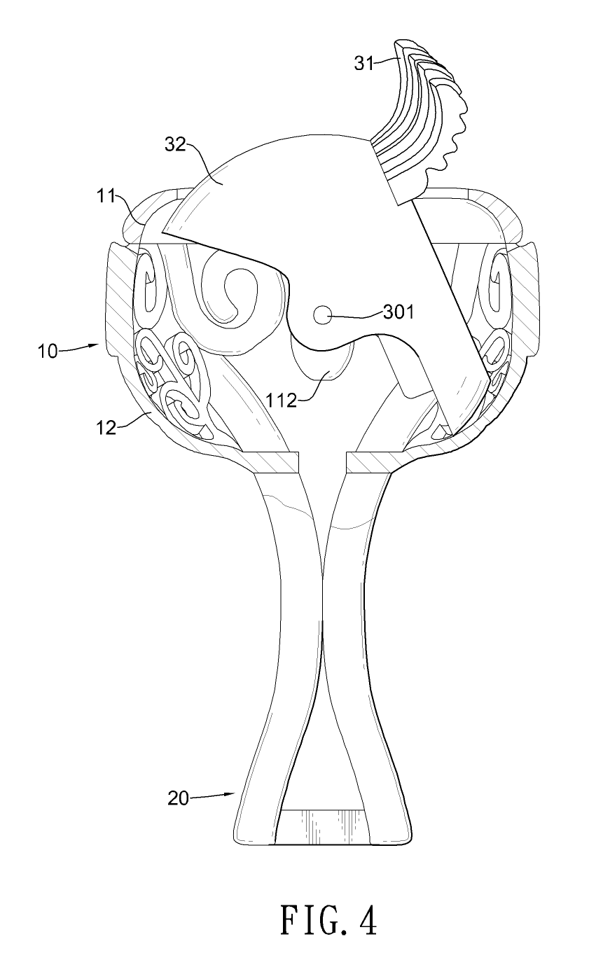

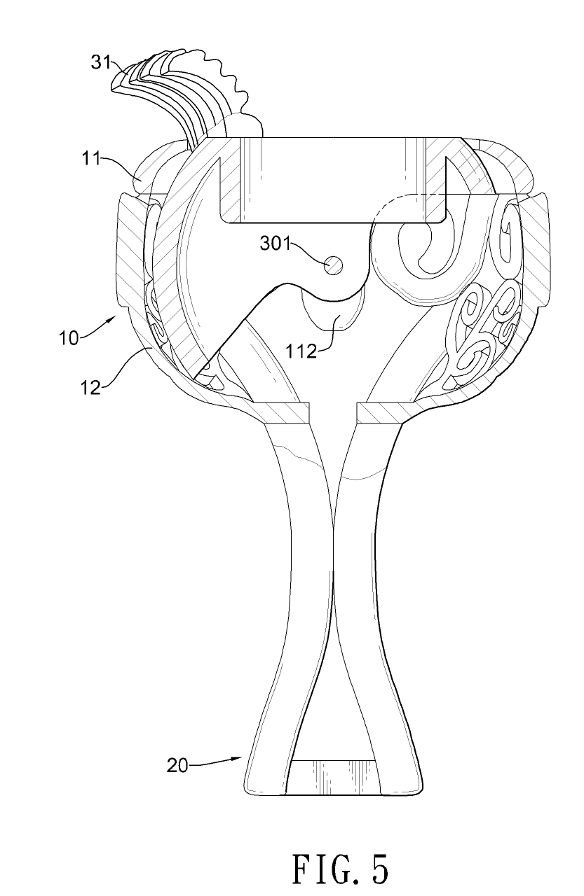

Together with reference to FIG. 3, FIG. 4 and FIG. 5, the base (20) is worn over a finger or the like and by positioning the ornament horizontally, one side of the pivoting cover (30) having the plumb portion (32) retain the through hole (33) centrally over the pivoting cover (30) so the gem hemmed inside the through hole (33) resembles a pupil and the projections (31) of the pivoting cover (30) tend to lean to another end opposite to the decorative ribs (111) on the body (10). When moved, the pivoting cover (30) pivots relative to the body (10), the central through hole (33) of the pivoting cover (30) moves between the opening (110) of the body (10) and the inner portion of the body (10), and the projections (31) of the pivoting cover (30) exhibit a movement between the decorative ribs (111) of the body, which resembles a blinking eyelid. It is obvious from the foregoing that wearer's movement simultaneously drives the pivoting cover (30) to pivotally rotate and generate a vivid blinking effect. As such, the overall styling is agile and lively, thereby urging persons to wear the eye-like ornament.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An eye-like ornament, comprising:
a hollow body has a top part, a bottom part and an opening centrally formed on the top part;
a base is connected with the bottom part of the body; and
a pivoting cover is pivotally mounted inside the body and having
a through hole is centrally formed thereon;
a plurality of projections is curled and projected outwards and separately formed on an outer surface beside the through hole; and
a plumb portion is formed on one end and abutting the projections by extending in a direction into the body.

2. The eye-like ornament as claim in claim 1, wherein the bottom part of the body is formed hollowed-out, the top part is mounted on the bottom part, the pivoting cover is pivotally mounted inside the top part, and the projections radiate form a center at the through hole and pass through the opening of the top part of the body.

3. The eye-like ornament as claim in claim 1, wherein the base is a ring connected with the bottom part of the body.

4. The eye-like ornament as claim in claim 2, wherein the base is a ring connected with the bottom part of the body.

5. The eye-like ornament as claim in claim 1, wherein a plurality of decorative ribs are radially mounted on a first end of an outer surface of the top part of the body abutting the opening.

6. The eye-like ornament as claim in claim 2, wherein a plurality of decorative ribs are radially mounted on a first end of an outer surface of the top part of the body abutting the opening.

7. The eye-like ornament as claim in claim 3, wherein a plurality of decorative ribs are radially mounted on a first end of an outer surface of the top part of the body abutting the opening.

8. The eye-like ornament as claim in claim 4, wherein a plurality of decorative ribs are radially mounted on a first end of an outer surface of the top part of the body abutting the opening.

9. The eye-like ornament as claim in claim 5, wherein a plurality of decorative ribs are radially mounted on a first end of an outer surface of the top part of the body abutting the opening.

10. The eye-like ornament as claim in claim 6, wherein a plurality of decorative ribs are radially mounted on a first end of an outer surface of the top part of the body abutting the opening.

11. The eye-like ornament as claim in claim 7, wherein a tab is formed on each of two corners of the top part of the body, the bottom part of the body has two sunken portions corresponding to the tabs for accommodating the tabs therein, and two ends of the pivoting cover are pivotally and coaxially mounted on two inner sides of the two tabs respectively.

12. The eye-like ornament as claim in claim 8, wherein a plurality of decorative ribs are radially mounted on a first end of an outer surface of the top part of the body abutting the opening.
